(19) United States
(12) Patent Application Publication
(10) Pub. No.: US 2026/0349610 A1
(43) Pub. Date: Nov. 5, 2026

(54) MULTI-STORAGE-DEVICE LOGICAL STORAGE POWER MANAGEMENT SYSTEM

(71) Applicant: Dell Products L.P., Round Rock, TX (US)

(72) Inventors: Raveendra Reddy Padala, Bangalore (IN); Rama Rao Bisa, Bangalore (IN); Manjunath Alaghatta Marulappa, Bangalore (IN); Vaishnavi Suchindran, Bangalore (IN); Ravi Shekhar Singh, Bangalore (IN); Raveendra Babu Madala, Agiripalli (IN); Jordan Hsiao Ping Chin, Austin, TX (US); Santosh Kumar Sahu, Bangalore (IN)

(21) Appl. No.: 19/198,236

(22) Filed: May 5, 2025

(51) Int. Cl. G06F 3/06

(52) U.S. Cl. CPC G06F 3/0625; G06F 3/0655; G06F 3/0679

(57) ABSTRACT

A multi-storage-device logical storage power management system includes a plurality of storage devices, and a storage controller device that is coupled to the plurality of storage devices. The storage controller device uses the plurality of storage devices to create a logical storage system. The storage controller device then identifies supported power states for each of the plurality of storage devices, and uses a plurality of different combinations of the supported power states identified for each of the plurality of storage devices to determine a plurality of logical storage system power states. The storage controller device may then configure the logical storage system to operate in any one of the plurality of logical storage system power states by configuring the plurality of storage devices to operate in a respective one of the different combinations of the supported power states identified for each of the plurality of storage devices.

### BACKGROUND

The present disclosure relates generally to information handling systems, and more particularly to managing power used by a logical storage system provided by multiple physical storage devices in an information handling system.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server devices and/or other computing devices known in the art, sometimes utilize logical storage volumes and/or other logical storage systems to store their data. For example, Hard Disk Drives (HDDs), Solid State Drives (SSDs), and/or other “physical” storage devices may be configured as a “fault tolerant” logical storage volume that provides “mirrored” storage that includes copies of the same data on different physical storage devices, a “concatenated” logical storage volume that combines multiple logical storage volumes into a single logical storage volume, a “striped” logical storage volume in which data is written across multiple physical storage devices to improve Input/Output (IO) performance, a “striped/parity” logical storage volume in which data and parity information are written across three or more physical storage devices so that data can be recovered from any physical storage device if that physical storage device becomes unavailable, and/or other logical storage volumes that would be apparent to one of skill in the art in possession of the present disclosure.

In another example, Compute eXpress Link (CXL) memory devices may provide the physical storage devices discussed above that are used to provide a logical memory space that provides the logical storage volume discussed above and that may be used by a host device (e.g., the server devices discussed above) in situations where the memory and/or IO needs of the host device are not satisfied. As will be appreciated by one of skill in the art in possession of the present disclosure, CXL technologies and protocols enable access to the logical memory space/logical storage volume provided by CXL memory devices as if they were present in the host device, and may include Type 1 CXL memory devices that provide a fully coherent cache and that are often used with accelerator devices (e.g., Smart Network Interface Controllers (SmartNICs), cache coherent devices, and other accelerator devices) with no local memory for low-latency and compute offload tasks such as compression, encryption, and network processing; Type 2 CXL memory devices that provide relatively high-bandwidth memory and that are often used with accelerator devices (Graphics Processing Units (GPUs), Field Programmable Gate Arrays (FPGAs), Artificial Intelligence (AI) accelerators, and other accelerator devices) with local memory for high bandwidth and low latency memory sharing while maintaining cache coherence between the accelerator device and Central Processing Unit (CPU) memory; and Type 3 memory devices that operate as expanded or pooled memory for the host device and that may be provided by Dynamic Random Access Memory (DRAM), CXL-based Non-Volatile Dual Inline Memory Modules (NVDIMMs) and/or other persistent memory, pooled memory modules, and/or other memory devices to allow scalability in memory-intensive applications such as large databases, AI workloads, and cloud computing.

However, the use of logical storage volumes like those described above raises a number of issues. For example, each of the physical storage devices that are used to provide a logical storage volume as discussed above may support a plurality of power states, and the number and details of power states supported by different physical storage devices will often vary, as power states for physical storage devices are not standardized. In many situations it is desirable to provide a power budget for the storage of data by a computing device (e.g., according to sustainability initiatives that direct the management of power consumption to reduce carbon emissions), but the use of a logical storage volume will prevent the ability to do so because the limitations discussed above prevent the accurate retrieval of power consumed by logical storage volumes, the accurate prediction of power consumption by logical storage volumes, the accurate control of power consumption by logical storage volumes, and/or other power management operations that one of skill in the art in possession of the present disclosure will recognize are required to provide and enforce such power budgets. The solution to such issues is to utilize only storage devices that support the same number of power states each having the same power state characteristics, which is unrealistic in the vast majority of scenarios.

Accordingly, it would be desirable to provide a logical storage power management system that addresses the issues discussed above.

### SUMMARY

According to one embodiment, an Information Handling System (IHS) includes a processing system; and a memory system that is coupled to the processing system and that includes instructions that, when executed by the processing system, cause the processing system to provide a logical storage system power management engine that is configured to: create, using a plurality of storage devices that are coupled to the processing system, a logical storage system; identify supported power states for each of the plurality of storage devices; determine, using a plurality of different combinations of the supported power states identified for each of the plurality of storage devices, a plurality of logical storage system power states; and configure the logical storage system to operate in a first logical storage system power state that is included in the plurality of logical storage system power states by configuring the plurality of storage devices to operate in a first combination of the supported power states identified for each of the plurality of storage devices.

### BRIEF DESCRIPTION OF THE DRAWINGS

FIG. 1 is a schematic view illustrating an embodiment of an Information Handling System (IHS).

FIG. 2 is a schematic view illustrating an embodiment of a multi-storage-device logical storage power management system that may be provided according to the teachings of the present disclosure.

FIG. 3 is a schematic view illustrating an embodiment of the multi-storage-device logical storage power management system of FIG. 2.

FIG. 4 is a schematic view illustrating an embodiment of the multi-storage-device logical storage power management system of FIG. 3.

FIG. 5 is a schematic view illustrating an embodiment of the multi-storage-device logical storage power management system of FIG. 3.

FIG. 6 is a schematic view illustrating an embodiment of the multi-storage-device logical storage power management system of FIG. 3.

FIG. 7 is a flow chart illustrating an embodiment of a method for managing power for a logical storage system provided by multiple storage devices.

FIG. 8A is a schematic view illustrating an embodiment of the multi-storage-device logical storage power management system of FIG. 2 operating during the method of FIG. 7.

FIG. 8B is a schematic view illustrating an embodiment of the multi-storage-device logical storage power management system of FIG. 2 operating during the method of FIG. 7.

FIG. 8C is a schematic view illustrating an embodiment of the multi-storage-device logical storage power management system of FIG. 2 operating during the method of FIG. 7.

FIG. 9 is a schematic view illustrating an embodiment of the multi-storage-device logical storage power management system of FIG. 2 operating during the method of FIG. 7.

FIG. 10 is a schematic view illustrating an embodiment of the multi-storage-device logical storage power management system of FIG. 2 operating during the method of FIG. 7.

FIG. 11A is a schematic view illustrating an embodiment of the multi-storage-device logical storage power management system of FIG. 2 operating during the method of FIG. 7.

FIG. 11B is a schematic view illustrating an embodiment of the multi-storage-device logical storage power management system of FIG. 2 operating during the method of FIG. 7.

FIG. 12 is a schematic view illustrating an embodiment of the multi-storage-device logical storage power management system of FIG. 2 operating during the method of FIG. 7.

FIG. 13 is a schematic view illustrating an embodiment of the multi-storage-device logical storage power management system of FIG. 2 operating during the method of FIG. 7.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

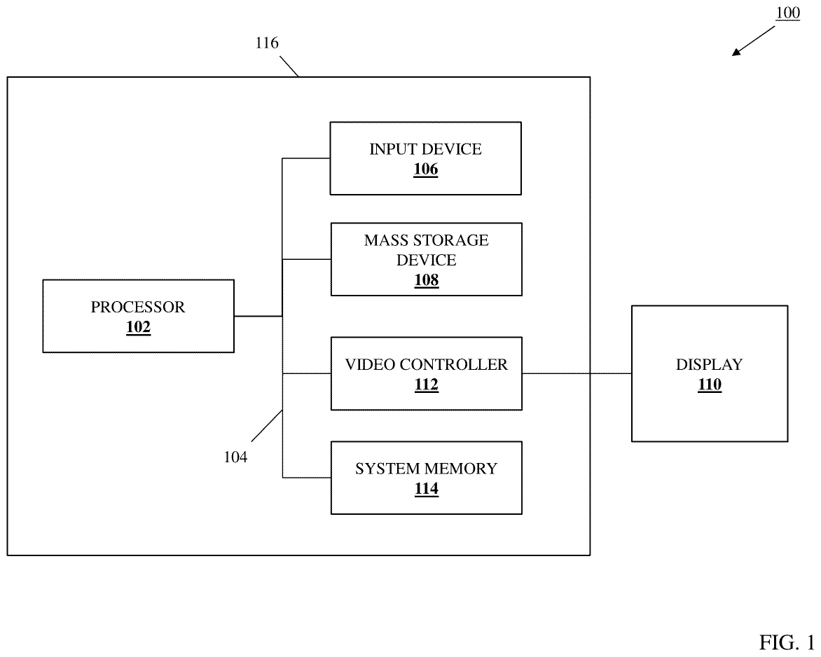

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

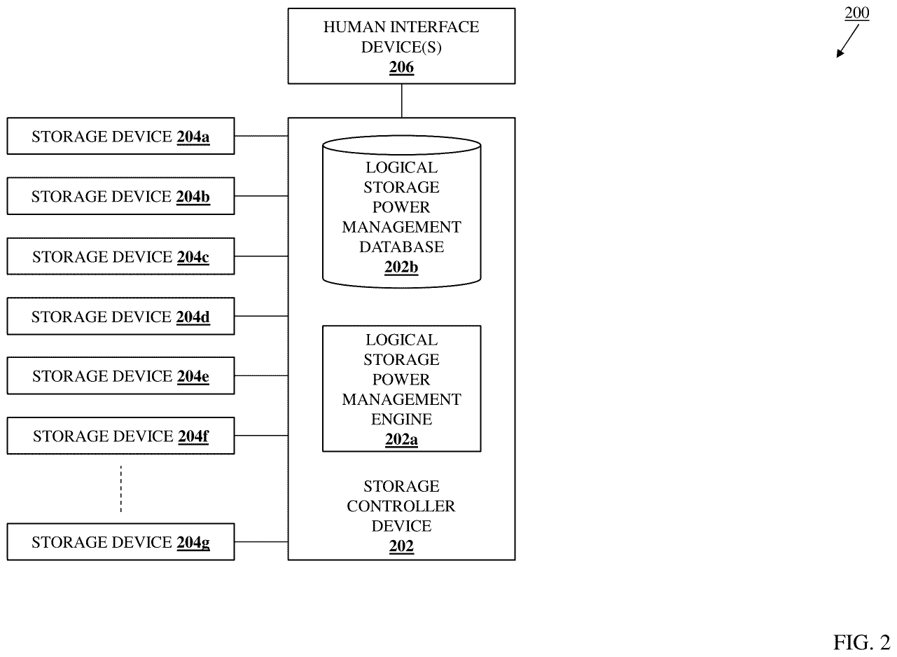

Referring now to FIG. 2, an embodiment of a multi-storage-device logical storage power management system 200 is illustrated that may be provided according to the teachings of the present disclosure. In the illustrated embodiment, the multi-storage-device logical storage power management system 200 includes a storage controller device 202. In an embodiment, the storage controller device 202 may be provided by and/or may be included in the IHS 100 discussed above with reference to FIG. 1, and/or may include some or all of the components of the IHS 100. In a specific example, the storage controller device 202 may be provided by a Redundant Array of Independent Disk (RAID) controller that one of skill in the art in possession of the present disclosure will recognize may be included in a server device, a storage system, and/or other computing devices that one of skill in the art in possession of the present disclosure will recognize may be configured to control a RAID storage system. In another specific example, the storage controller device 202 may be provided by an operating system that one of skill in the art in possession of the present disclosure will recognize may be included in a server device and/or other computing devices that one of skill in the art in possession of the present disclosure will recognize may be configured to control a storage system. However, while two specific examples have been provided, one of skill in the art in possession of the present disclosure will appreciate how the storage controller device 202 may be provided in a variety of manners that will fall within the scope of the present disclosure as well.

The storage controller device 202 may include a processing system (not illustrated, but which may include or be similar to the processor 102 discussed above with reference to FIG. 1) and a memory system (not illustrated, but which may include or be similar to the memory 114 discussed above with reference to FIG. 1) that is coupled to the processing system and that includes instructions that, when executed by the processing system, cause the processing system to provide a logical storage power management engine 202a that is configured to perform the functionality of the logical storage power management engines and/or storage controller devices discussed below. The storage controller device 202 may also include a storage system (not illustrated, but which may include or be similar to the storage 108 discussed above with reference to FIG. 1) that is coupled to the logical storage power management engine 202a (e.g., via a coupling between the storage system and the processing system) and that includes a logical storage power management database 202b that is configured to store any of the information utilized by the logical storage power management engine 202a discussed below.

As illustrated, a plurality of storage devices 204a, 204b, 204c, 204d, 204e, 204f, and up to 204g are coupled to the storage controller device 202. As will be appreciated by one of skill in the art in possession of the present disclosure, in some examples the storage devices 204a-204g may be provided by mass storage devices that are configured to operate in RAID (e.g., in the specific example in which the storage controller device 202 is a RAID controller), while in other examples the storage devices 204a-204g may be provided by any other mass storage devices known in the art (e.g., in the specific example in which the storage controller device 202 is an operating system). As such, the storage devices 204a-204g may be provided by Hard Disk Drive (HDD) storage devices, Solid State Drive (SSD) storage devices (e.g., Non-Volatile Memory express (NVMe) SSD storage devices), “flash” storage devices, and/or other any other mass storage devices that would be apparent to one of skill in the art in possession of the present disclosure. Furthermore, and as described in further detail below, while the storage devices 204a-204g are described as being provided by mass storage devices, one of skill in the art in possession of the present disclosure will appreciate how memory devices and other storage devices will fall within the scope of the present disclosure as well.

In some embodiments, one or more human interface devices 206 may be coupled to the storage controller device 202 and, as described below, may be provided by input devices (e.g., mouse devices, keyboard devices, etc.), display devices, Graphical User Interfaces (GUIs), and/or any other human interface devices that would be apparent to one of skill in the art in possession of the present disclosure. However, while a specific multi-storage-device logical storage power management system 200 has been illustrated and described, one of skill in the art in possession of the present disclosure will recognize that the multi-storage-device logical storage power management system (or other devices operating according to the teachings of the present disclosure in a manner similar to that described below for the multi-storage-device logical storage power management system 200) may include a variety of components and/or component configurations for providing conventional storage system functionality, as well as the functionality discussed below, while remaining within the scope of the present disclosure as well.

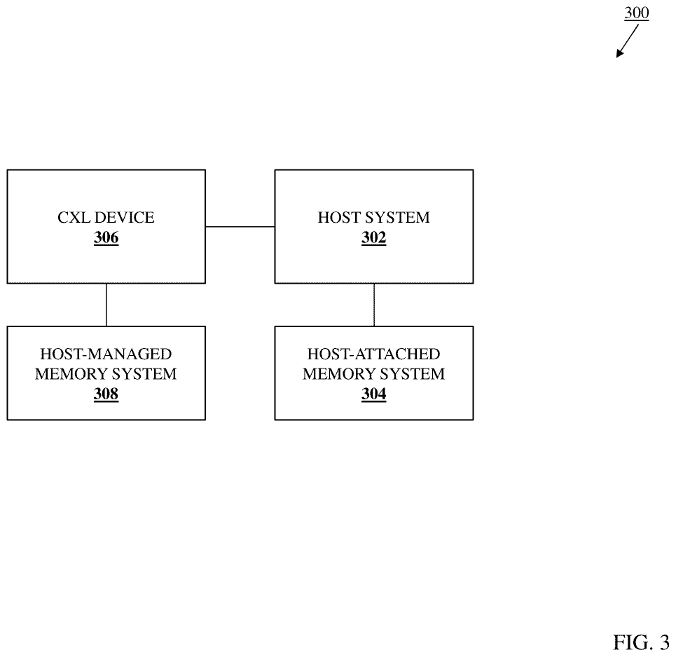

Referring now to FIG. 3, an embodiment of a Compute eXpress Logical (CXL) memory system 300 is illustrated that may provide the multi-storage-device logical storage power management system 200 discussed above with reference to FIG. 2. In the illustrated embodiment, the CXL memory system 300 includes a host system 302 that may be provided by a processing system in a host device such as a server device. As will be appreciated by one of skill in the art in possession of the present disclosure and as described below, the host system 302 may include a root complex having a memory controller, a host/home agent, an IO bridge having an IO Memory Management Unit (IOMMU), as well as any other host system components known in the art. As illustrated, the host system 302 may include a “host-attached” memory system 304 that one of skill in the art in possession of the present disclosure will appreciate may be provided by memory devices in the server device that includes the host system 302. A CXL device 306 is coupled to the host system 302 and may provide the storage controller device 202 discussed above with reference to FIG. 2, with the CXL device 306 coupling the host system 302 to a “host-managed” memory system 308 that may include any of a variety of memory devices that are external to the server device that includes the host system 302, and that may provide the storage devices 204a-204g discussed above with reference to FIG. 2.

As will be appreciated by one of skill in the art in possession of the present disclosure, the host system 302 may utilize the host-attached memory system 304 via the memory controller in its root complex and using any of a variety of conventional techniques known in the art, and may utilize the hot-managed memory system 308 through the CXL device 306 via the host/home agent in its root complex. To provide a specific example in which the CXL device 306 is a Type 3 CXL device provided by a CXL memory expander, the IOMMU of the IO bridge in the root complex of the host system 302 may utilize the CXL.io protocol to communicate with the CXL memory expander to discover, enumerate, and configure the host-managed memory system 308, while the host/home agent in the root complex of the host system 302 may use the CXL.mem protocol to communicate with the CXL memory expander to utilize the host-managed memory system 308.

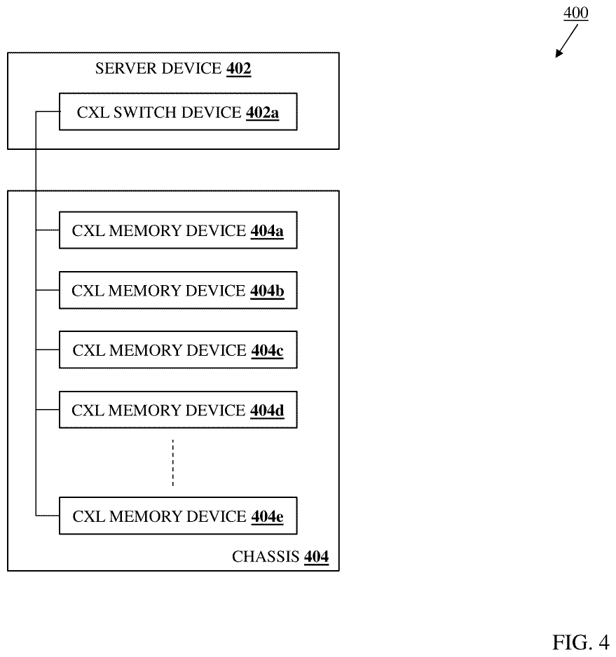

With reference to FIG. 4, a specific example of a CXL memory system 400 is illustrated that may include the CXL memory system 300 of FIG. 3 and may provide the multi-storage-device logical storage power management system 200 discussed above. The CXL memory system 400 includes a server device 402 that may include the host system 302 of FIG. 3, with the server device 402 including a CXL switch device 402a that provides the CXL device 306 of FIG. 3 and the storage controller device 202 of FIG. 2. The CXL memory system 400 also includes a chassis 404 that one of skill in the art in possession of the present disclosure will recognize is provided by a “Just a Bunch Of Memory” (JBOM) chassis that houses a plurality of CXL memory devices 404a, 404b, 404c, 404d, and up to 404f that are coupled to the CXL switch device 402a and that provide the host-managed memory system 308 of FIG. 3 and the storage devices 204a-204g of FIG. 2. As will be appreciated by one of skill in the art in possession of the present disclosure, the server device 402 may utilize the CXL switch device 402a to access logical storage volume(s) (e.g., logical memory space(s)) and/or other logical storage systems provided by any combination of the CXL memory devices 404a-404e.

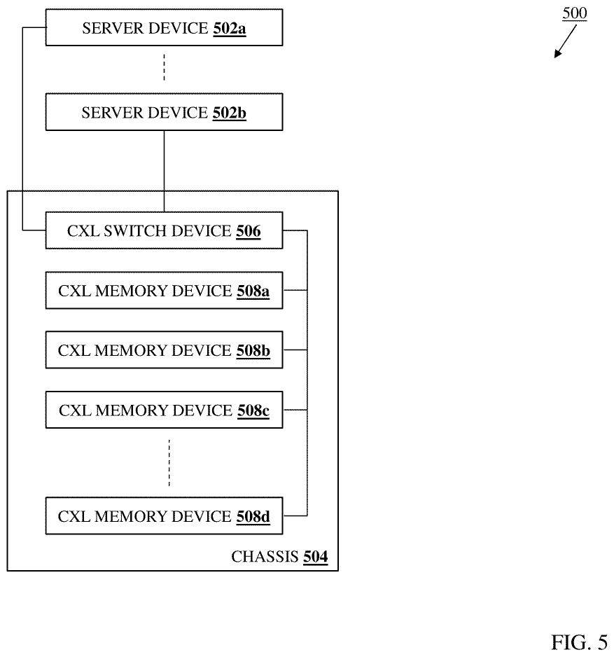

With reference to FIG. 5, another specific example of a CXL memory system 500 is illustrated that may include the CXL memory system 300 of FIG. 3 and may provide the multi-storage-device logical storage power management system 200 discussed above. The CXL memory system 500 includes a plurality of server devices 502a and up to 502b that may each include a respective host system that is similar to the host system 302 of FIG. 3. The CXL memory system 500 also includes a chassis 504 that one of skill in the art in possession of the present disclosure will recognize is provided by a “Just a Bunch Of Memory” (JBOM) chassis that houses a CXL switch device 506 that provides the CXL device 306 of FIG. 3 and the storage controller device 202 of FIG. 2, and a plurality of CXL memory devices 508a, 508b, 508c, and up to 508d that are coupled to the CXL switch device 506 and that provide the host-managed memory system 308 of FIG. 3 and the storage devices 204a-204g of FIG. 2. As will be appreciated by one of skill in the art in possession of the present disclosure, any of the server devices 502a-502b may utilize the CXL switch device 506 to access logical storage volume(s) (e.g., logical memory space(s)) and/or other logical storage systems provided by any combination of the CXL memory devices 508a-508d.

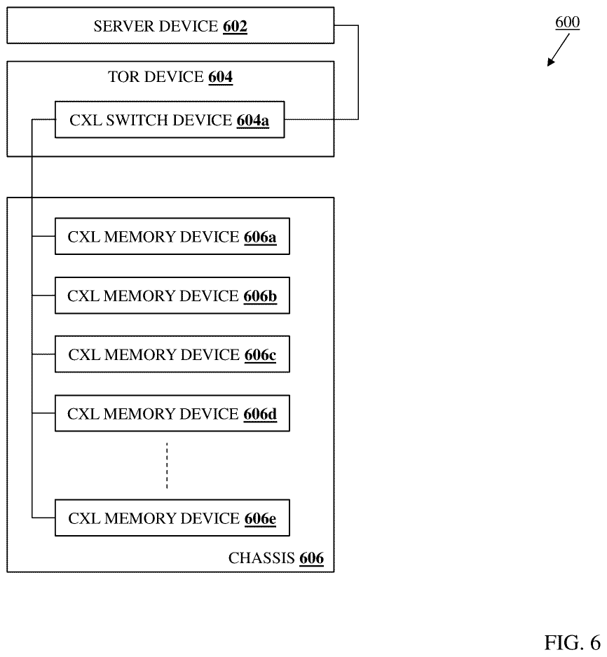

With reference to FIG. 6, another specific example of a CXL memory system 600 is illustrated that may include the CXL memory system 300 of FIG. 3 and may provide the multi-storage-device logical storage power management system 200 discussed above. The CXL memory system 600 includes a server device 602 that may include the host system 302 of FIG. 3. The CXL memory system 600 also includes a Top Of Rack (TOR) device 604 having a CXL switch device 604a that provides the CXL device 306 of FIG. 3 and the storage controller device 202 of FIG. 2, and that is coupled to the server device 602. The CXL memory system 600 also includes a chassis 606 that one of skill in the art in possession of the present disclosure will recognize is provided by a “Just a Bunch Of Memory” (JBOM) chassis that houses a plurality of CXL memory devices 606a, 606b, 606c, 606d, and up to 606e that are each coupled to the CXL switch device 604a and that provide the host-managed memory system 308 of FIG. 3 and the storage devices 204a-204g of FIG. 2. As will be appreciated by one of skill in the art in possession of the present disclosure, the server device 602 may utilize the CXL switch device 506 in the TOR device 604 to access logical storage volume(s) (e.g., logical memory space(s)) and/or other logical storage systems provided by any combination of the CXL memory devices 606a-606e.

However, while several different examples of the multi-storage-device logical storage power management system of the present disclosure have been illustrated and described, one of skill in the art in possession of the present disclosure will appreciate how a variety of storage devices and storage controller devices may be used to provide any of a variety of logical storage systems that may have their power managed via the teaching of the present disclosure.

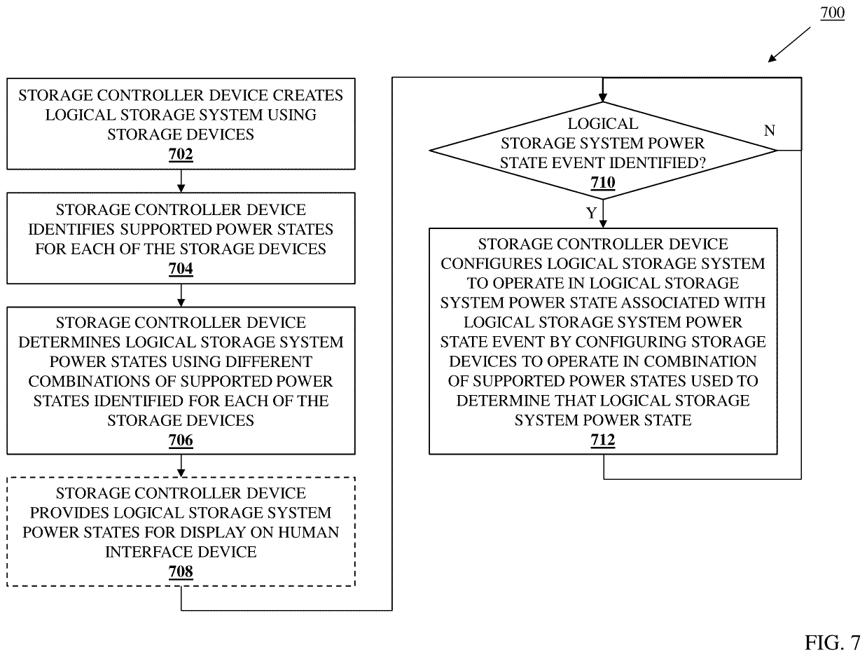

Referring now to FIG. 7, an embodiment of a method 700 for managing power for a logical storage system provided by multiple storage devices is illustrated. As discussed below, the systems and methods of the present disclosure provide for the determination of power states for a logical storage system using different combinations of power states supported by the storage devices that provide that logical storage system. For example, the multi-storage-device logical storage power management system of the present disclosure may include a plurality of storage devices, and a storage controller device that is coupled to the plurality of storage devices. The storage controller device uses the plurality of storage devices to create a logical storage system. The storage controller device then identifies supported power states for each of the plurality of storage devices, and uses a plurality of different combinations of the supported power states identified for each of the plurality of storage devices to determine a plurality of logical storage system power states. The storage controller device may then configure the logical storage system to operate in any one of the plurality of logical storage system power states by configuring the plurality of storage devices to operate in a respective one of the different combinations of the supported power states identified for each of the plurality of storage devices. As such, the management of power utilized by a logical storage system provided using a plurality of storage devices that support a variety of different power state levels and power state characteristics is enabled.

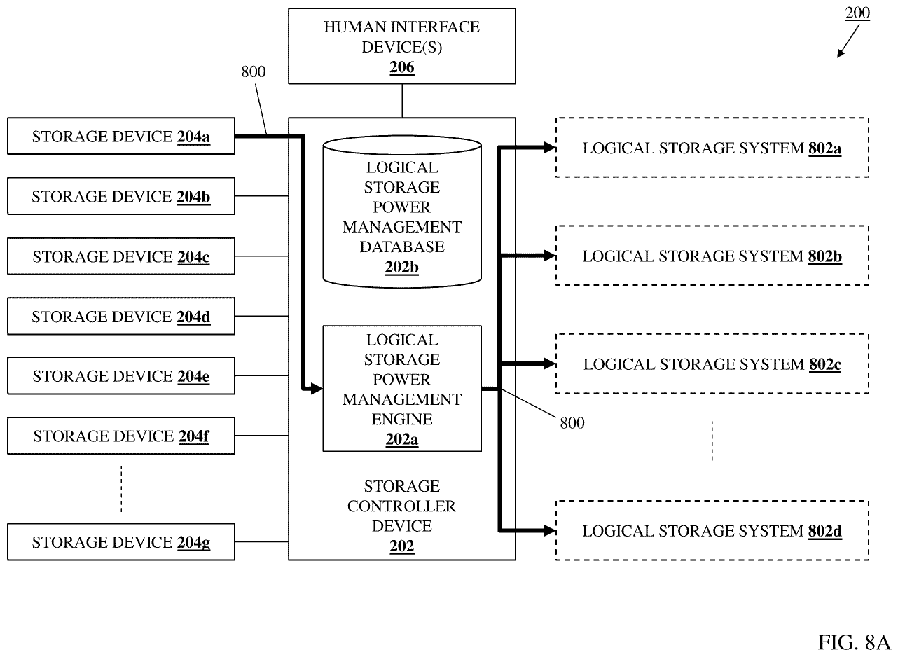

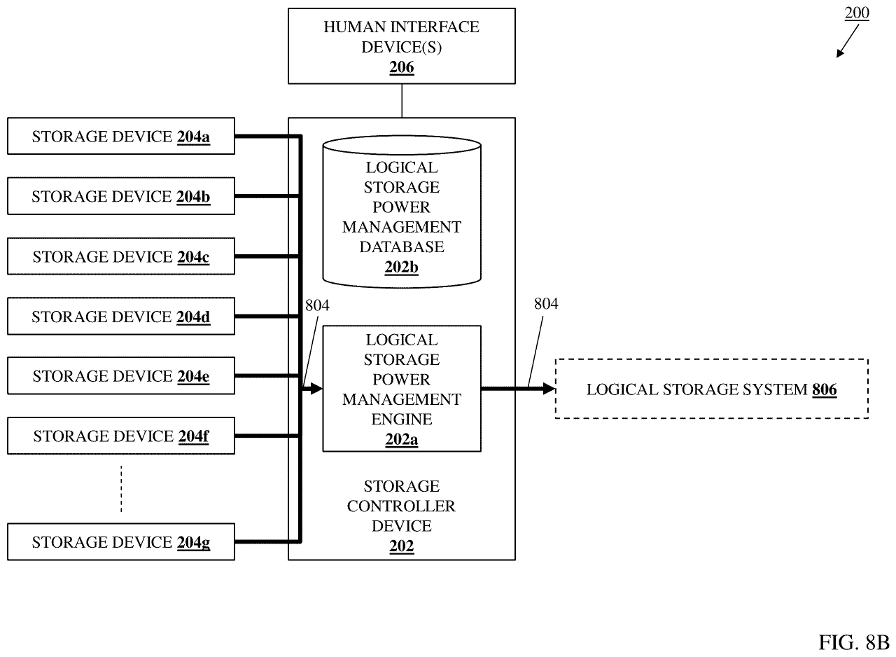

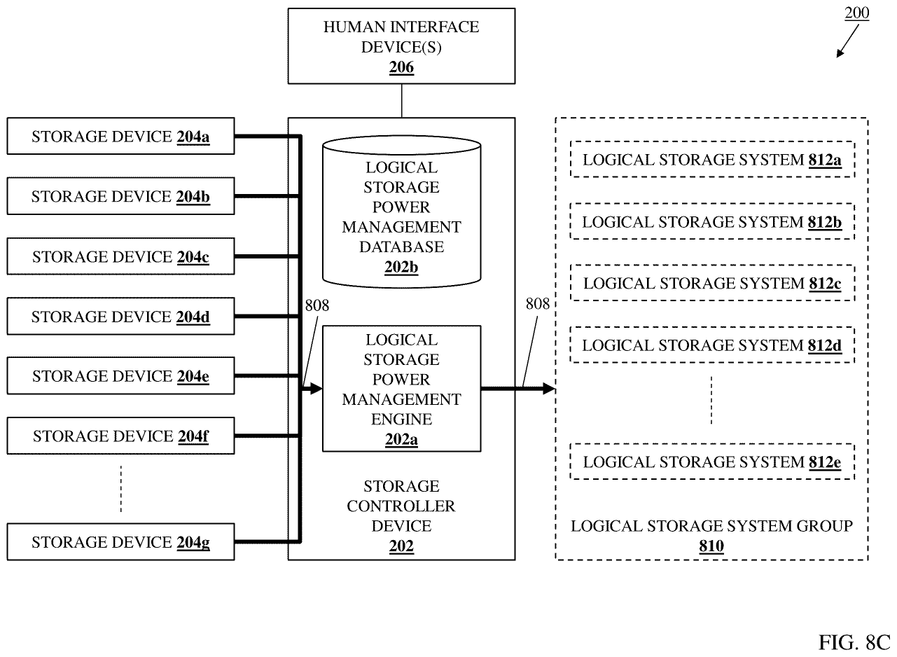

The method 700 begins at block 702 where a storage controller device creates a logical storage system using storage devices. With reference to FIG. 8A, in an embodiment of block 702, the logical storage power management engine 202a in the storage controller device 202 may perform logical storage system creation operations 800 that, in the illustrated example, include using the storage device 204a to create a plurality of logical storage systems 802a, 802b, 802c, and up to 802d (e.g., respective logical storage volumes) using any of a variety of techniques (e.g., RAID logical storage volume creation techniques, CXL logical memory space creation techniques, and/or other logical storage system creation techniques that would be apparent to one of skill in the art in possession of the present disclosure). As such, one of skill in the art in possession of the present disclosure will appreciate how FIG. 8A provides an example of the use of a single physical storage device (i.e., the storage device 204a) to create a plurality of logical storage volumes/logical memory spaces. However, one of skill in the art in possession of the present disclosure will appreciate how different numbers and combinations of the storage devices 204a-204g may be used to create the plurality of logical storage systems 802a, 802b, 802c, and up to 802d while remaining within the scope of the present disclosure as well.

With reference to FIG. 8B, in an embodiment of block 702, the logical storage power management engine 202a in the storage controller device 202 may perform logical storage system creation operations 804 that, in the illustrated example, include using the storage devices 204a-204g to create a logical storage system 806 (e.g., a logical storage volume) using any of a variety of techniques (e.g., RAID logical storage volume creation techniques, CXL logical memory space creation techniques, and/or other logical storage system creation techniques that would be apparent to one of skill in the art in possession of the present disclosure). As such, one of skill in the art in possession of the present disclosure will appreciate how FIG. 8B provides an example of the use of a multiple physical storage device (i.e., all of the storage devices 204a-204g in the specific examples of FIG. 8B) to create a single logical storage volume/logical memory space. However, one of skill in the art in possession of the present disclosure will appreciate how different numbers and combinations of the storage devices 204a-204g may be used to create the logical storage system 806 while remaining within the scope of the present disclosure as well.

With reference to FIG. 8C, in an embodiment of block 702, the logical storage power management engine 202a in the storage controller device 202 may perform logical storage system creation operations 808 that, in the illustrated example, include using the storage devices 204a-204g to create a logical storage system group 810 having a plurality of logical storage systems 812a, 812b, 812c, 812d, and up to 812e (e.g., respective logical storage volumes) using any of a variety of techniques (e.g., RAID logical storage volume creation techniques, CXL logical memory space creation techniques, and/or other logical storage system creation techniques that would be apparent to one of skill in the art in possession of the present disclosure). As such, one of skill in the art in possession of the present disclosure will appreciate how FIG. 8C provides an example of the use of a multiple physical storage device (i.e., all of the storage devices 204a-204g in the example of FIG. 8C) to create a logical storage volume/logical memory space group having a plurality of logical storage volumes/logical memory spaces. However, one of skill in the art in possession of the present disclosure will appreciate how different numbers and combinations of the storage devices 204a-204g may be used to create the logical storage system group 810 while remaining within the scope of the present disclosure as well.

In the examples provided below, the embodiment illustrated of FIG. 8B is used to describe the operation of the multi-storage-device logical storage power management system of the present disclosure with a single logical storage system provided using multiple physical storage devices. However, one of skill in the art in possession of the present disclosure will appreciate how the multi-storage-device logical storage power management functionality described herein may be performed for each logical storage system 802a-802d in FIG. 8A or each logical storage system 812a-812e in FIG. 8C similarly as described below for the logical storage system 806 in FIG. 8B using the physical storage devices used to provide that logical storage system while remaining within the scope of the present disclosure as well.

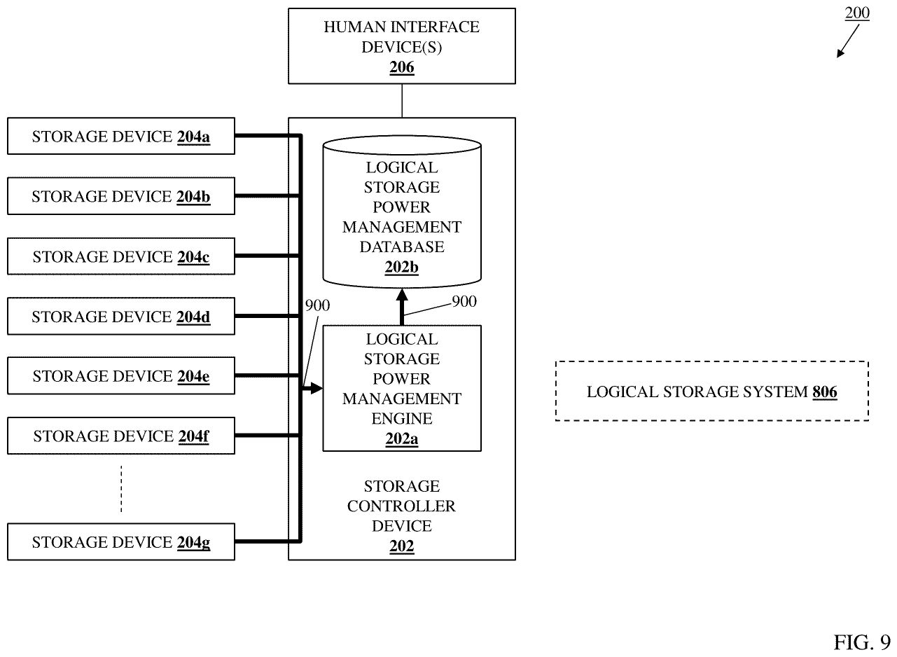

The method 700 then proceeds to block 704 where the storage controller device identifies supported power states for each of the storage devices. With reference to FIG. 9, in an embodiment of block 704, the logical storage power management engine 202a in the storage controller device 202 may perform storage device supported power state identification operations 900 that include identifying power states that are supported by each of the storage devices 204a-204g (“supported power states”) that were used to create the logical storage system 806, and storing those supported power states in the logical storage power management database 202b.

Consider a specific example in which three storage devices (e.g., SSD storage devices, CXL memory devices, etc.) are used to provide the logical storage system at block 702, with the first storage device (“SD₁”) supporting two power states (P₀ [POWER_{MIN}=12 W, POWER_{MAX}=14 W] and P₁ [POWER_{MIN}=10 W, POWER_{MAX}=12 W]), the second storage device (“SD₂”) supporting three power states (P₀ [POWER_{MIN}=14 W, POWER_{MAX}=20 W], P₁ [POWER_{MIN}=12 W, POWER_{MAX}=16 W], and P₂ [POWER_{MIN}=11 W, POWER_{MAX}=12 W]), and the third storage device (“SD₃”) supporting four power states (P₀ [POWER_{MIN}=18 W, POWER_{MAX}=20 W], P₁ [POWER_{MIN}=16 W, POWER_{MAX}=18 W], P₂ [POWER_{MIN}=13 W, POWER_{MAX}=16 W], and P₃ [POWER_{MIN}=10 W, POWER_{MAX}=12 W]). As will be appreciated by one of skill in the art in possession of the present disclosure, each power state P_{X} in the example above defines a minimum power consumption (“POWER_{MIN}”) and maximum power consumption (“POWER_{MAX}”) for that storage device when operating in that power state.

As will be appreciated by one of skill in the art in possession of the present disclosure, the storage device supported power state identification operations 900 by the logical storage power management engine 202a in the storage controller device 202 at block 704 may include identifying (e.g., in an Electronically Erasable Read-Only Memory (EEPROM) or other power state information storage subsystem) each of the power states supported by the storage devices 204a-204g that were used to create the logical storage system 806, and storing those supported power states in the logical storage power management database 202b in association with the logical storage system 806. Thus, for any logical storage system, each of the power states supported by the physical storage devices used to provide that logical storage system may be stored in the logical storage power management database 202b in association with that logical storage system following block 704.

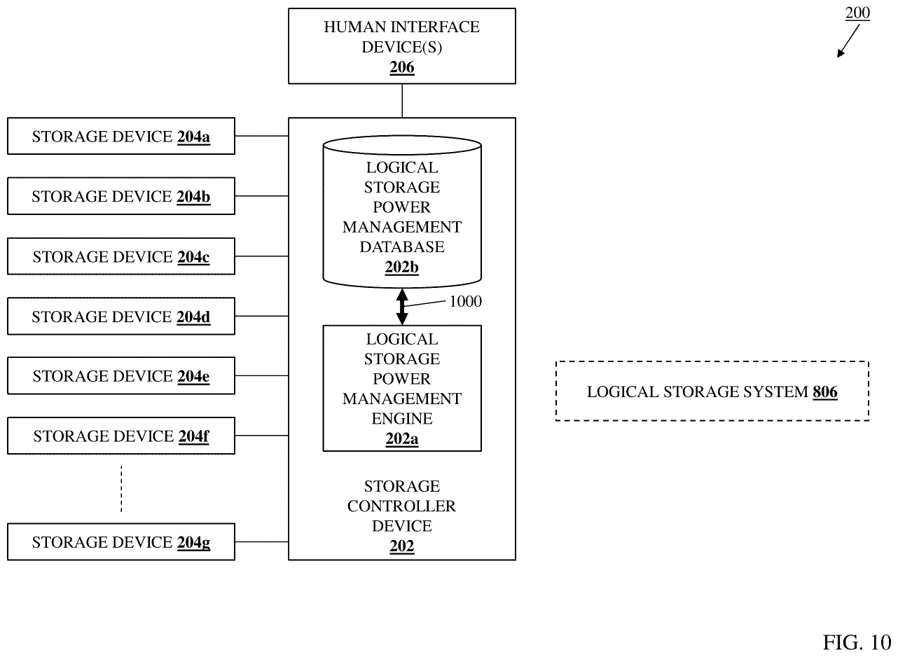

The method 700 then proceeds to block 706 where the storage controller device determines logical storage system power states using different combinations of the supported power states identified for each of the storage devices. With reference to FIG. 10, in an embodiment of block 706, the logical storage power management engine 202a in the storage controller device 202 may perform logical storage system power state determination operations 1000 that include accessing the supported power states for the storage devices 204a-204g that are associated with the logical storage system 806 in the logical storage power management database 202b in the storage controller device 202 (i.e., accessing supported power states for each physical storage device used to create the logical storage system for which the logical storage system power states are being determined), and determining a respective logical storage system power state for each combination of the supported power states for those storage devices.

Continuing with the example above in which the three storage devices SD₁, SD₂, and SD₃ are used to provide the logical storage system at block 702, the logical storage system power state determination operations 1000 performed by the logical storage power management engine 202a may result in the determination of the following logical storage system power states for each combination of supported power states for the first storage device SD₁, the second storage device SD₂, and the third storage device SD₃ (identified as “SD₁ P_{X}, SD₂ P_{Y}, SD₃ P_{Z}” below), with the sum of the minimum power consumptions defined by the supported power states in any particular combination providing the minimum power consumption (“POWER_{MIN}”) for the logical storage system in that logical storage system power state, and the sum of the maximum power consumptions defined by the supported power states in any particular combination providing the maximum power consumption (“POWER_{MAX}”) for the logical storage system in that logical storage system power state:
1^{st} power state: SD₁ P₀, SD₂ P₀, SD₃ P₀ [POWER_{MIN}=44 W, POWER_{MAX}=54 W]
2^{nd} power state: SD₁ P₀, SD₂ P₀, SD₃ P₁ [POWER_{MIN}=42 W, POWER_{MAX}=52 W]
3^{rd} power state: SD₁ P₀, SD₂ P₀, SD₃ P₂ [POWER_{MIN}=39 W, POWER_{MAX}=50 W]
4^{th} power state: SD₁ P₀, SD₂ P₀, SD₃ P₃ [POWER_{MIN}=36 W, POWER_{MAX}=46 W]
5^{th} power state: SD₁ P₀, SD₂ P₁, SD₃ P₀ [POWER_{MIN}=42 W, POWER_{MAX}=50 W]
6^{th} power state: SD₁ P₀, SD₂ P₁, SD₃ P₁ [POWER_{MIN}=40 W, POWER_{MAX}=48 W]
7^{th} power state: SD₁ P₀, SD₂ P₁, SD₃ P₂ [POWER_{MIN}=37 W, POWER_{MAX}=46 W]
8^{th} power state: SD₁ P₀, SD₂ P₁, SD₃ P₃ [POWER_{MIN}=34 W, POWER_{MAX}=42 W]
9^{th} power state: SD₁ P₀, SD₂ P₂, SD₃ P₀ [POWER_{MIN}=41 W, POWER_{MAX}=46 W]
10^{th} power state: SD₁ P₀, SD₂ P₂, SD₃ P₁ [POWER_{MIN}=39 W, POWER_{MAX}=44 W]
11^{th} power state: SD₁ P₀, SD₂ P₂, SD₃ P₂ [POWER_{MIN}=36 W, POWER_{MAX}=42 W]
12^{th} power state: SD₁ P₀, SD₂ P₂, SD₃ P₃ [POWER_{MIN}=33 W, POWER_{MAX}=38 W]
13^{th} power state: SD₁ P₁, SD₂ P₀, SD₃ P₀ [POWER_{MIN}=42 W, POWER_{MAX}=52 W]
14^{th} power state: SD₁ P₁, SD₂ P₀, SD₃ P₁ [POWER_{MIN}=40 W, POWER_{MAX}=50 W]
15^{th} power state: SD₁ P₁, SD₂ P₀, SD₃ P₂ [POWER_{MIN}=37 W, POWER_{MAX}=48 W]
16^{th} power state: SD₁ P₁, SD₂ P₀, SD₃ P₃ [POWER_{MIN}=34 W, POWER_{MAX}=44 W]
17^{th} power state: SD₁ P₁, SD₂ P₁, SD₃ P₀ [POWER_{MIN}=40 W, POWER_{MAX}=48 W]
18^{th} power state: SD₁ P₁, SD₂ P₁, SD₃ P₁ [POWER_{MIN}=38 W, POWER_{MAX}=46 W]
19^{th} power state: SD₁ P₁, SD₂ P₁, SD₃ P₂ [POWER_{MIN}=35 W, POWER_{MAX}=44 W]
20^{th} power state: SD₁ P₁, SD₂ P₁, SD₃ P₃ [POWER_{MIN}=32 W, POWER_{MAX}=40 W]
21^{st} power state: SD₁ P₁, SD₂ P₂, SD₃ P₀ [POWER_{MIN}=39 W, POWER_{MAX}=44 W]
22^{nd} power state: SD₁ P₁, SD₂ P₂, SD₃ P₁ [POWER_{MIN}=37 W, POWER_{MAX}=42 W]
23^{rd} power state: SD₁ P₁, SD₂ P₂, SD₃ P₂ [POWER_{MIN}=34 W, POWER_{MAX}=40 W]
24^{th} power state: SD₁ P₁, SD₂ P₂, SD₃ P₃ [POWER_{MIN}=31 W, POWER_{MAX}=36 W]

Furthermore, one of skill in the art in possession of the present disclosure will recognize that some of the logical storage system power states determined at block 708 may be duplicative of each other and may be consolidated into a single logical storage system power state. For example, if the logical storage power management engine 202a determines that a first combination and a second combination of the supported power states identified for storage devices that were used to create a logical storage system both provide respective logical storage system power states having the same power state characteristics (e.g., the same minimum and maximum power in the examples provided herein), it may define a logical storage system power state having those power state characteristics that may be provided by either that first combination or that second combination of the supported power states.

Continuing with the specific example above in which the logical storage system power states were determined using combinations of the three storage SD₁, SD₂, and SD₃ that provide the logical storage system, the 2^{nd} power state and the 13^{th} power state each provide for a minimum power consumption (POWER_{MIN}) of 42 W and a maximum power consumption (POWER_{MAX}) of 52 W for the logical storage system, the 6^{th} power state and the 17^{th} power state each provide for a minimum power consumption (POWER_{MIN}) of 40 W and a maximum power consumption (POWER_{MAX}) of 48 W for the logical storage system, and the 10^{th} power state and the 21^{st} power state each provide for a minimum power consumption (POWER_{MIN}) of 39 W and a maximum power consumption (POWER_{MAX}) of 44 W for the logical storage system.

As such, the logical storage system power state determination operations 1000 performed by the logical storage power management engine 202a may include consolidating duplicative logical storage system power states into a single logical storage system power state (e.g., consolidating the 2^{nd} power state and the 13^{th} power state into a single logical storage system power state that may be provided by either the supported power state combination (SD₁ P₀, SD₂ P₀, SD₃ P₁) or the supported power state combination (SD₁ P₁, SD₂ P₀, SD₃ P₀), consolidating the 6^{th} power state and the 17^{th} power state into a single logical storage system power state that may be provided by either the supported power state combination (SD₁ P₀, SD₂ P₁, SD₃ P₁) or the supported power state combination (SD₁ P₁, SD₂ P₁, SD₃ P₀), and consolidating the 10^{th} power state and the 21^{st} power state into a single logical storage system power state that may be provided by either the supported power state combination (SD₁ P₀, SD₂ P₂, SD₃ P₁) or the supported power state combination (SD₁ P₁, SD₂ P₂, SD₃ P₀) in the example above). Thus, in the specific example provided above, a total of 21 distinct logical storage system power states are determined for the logical storage system provided by the three storage devices SD₁, SD₂, and SD₃ at block 706.

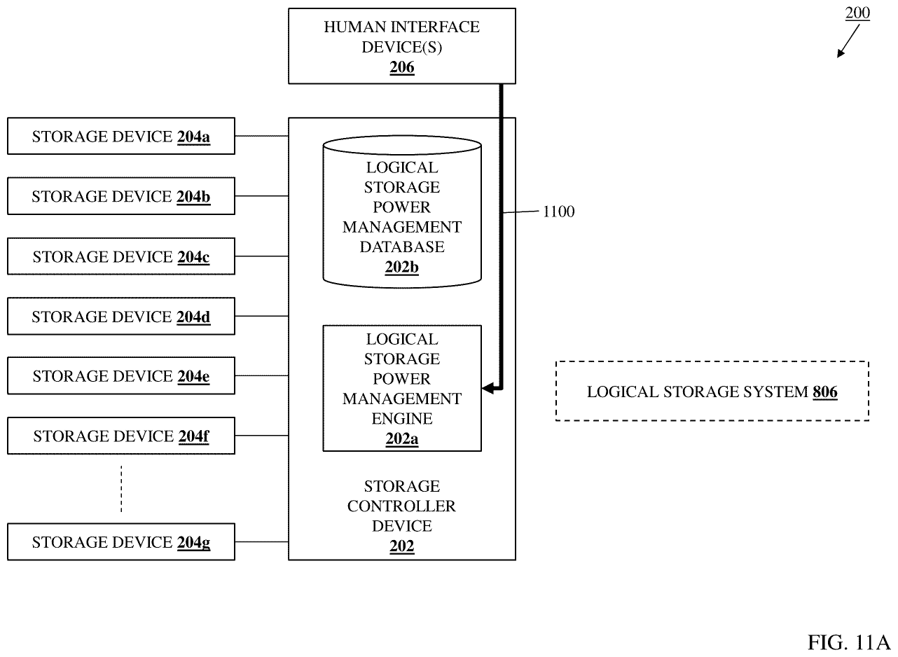

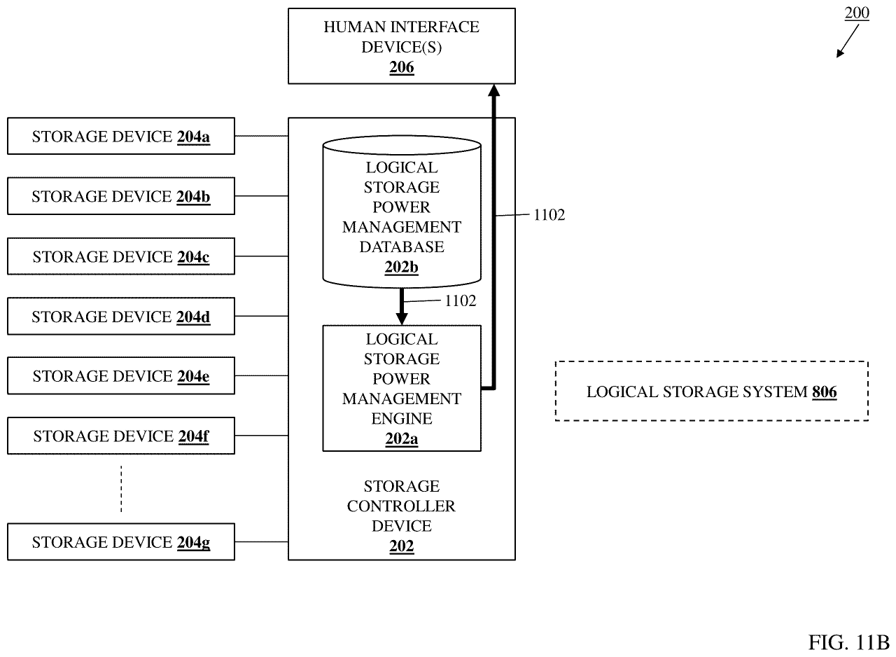

The method 700 may then proceed to optional block 708 where the storage controller device may provide the logical storage system power states for display on a human interface device. With reference to FIG. 11A, in some embodiments of optional block 708, the logical storage power management engine 202a in the storage controller device 202 may perform logical storage system power state display request receiving operations 1100 that may include receiving a request from the human interface device(s) 206 for the logical storage system power states for the logical storage system 806. For example, a user may utilize a Graphical User Interface (GUI), input device, and/or other human interface device to generate and transmit a request to the logical storage power management engine 202a for the logical storage system power states for the logical storage system 806.

With reference to FIG. 11B, in response to receiving the request, the logical storage power management engine 202a may perform logical storage system power state provisioning operations 1102 that may include retrieving the logical storage system power states determined for the logical storage system 806, and providing those logical storage system power states to the human interface device(s) 206. For example, in response to receiving the request, the logical storage power management engine 202a may provide the logical storage system power states determined for the logical storage system 806 for display on a display device or other human interface device (e.g., on the GUI through which the user requested the logical storage system power states for the logical storage system 806). Continuing with the specific example above in which the three storage devices SD₁, SD₂, and SD₃ were used to provide the logical storage system, the logical storage power management engine 202a may provide the 21 distinct logical storage system power states for display on a GUI that allows a user to select any one of those logical storage system power states for the logical storage system for which they were determined. However, while the logical storage system power states have been described as being displayed to a user, one of skill in the art in possession of the present disclosure will appreciate how optional block 708 may be skipped, and the logical storage system power states may be utilized as described below without displaying them to a user while remaining within the scope of the present disclosure as well.

The method 700 then proceeds to decision block 710 where the method 700 proceeds depending on whether a logical storage system power state event has been identified. In an embodiment, at decision block 710, the logical storage power management engine 202a in the storage controller device 202 may monitor for logical storage system power states events that may include a situation in which a “default” logical storage system power state is instructed, a request from a user to configure the logical storage system 806 to operate in a particular logical storage system power state, a change in the power available to the storage devices 204a-204g that were used to create the logical storage system 806 (e.g., a reduction in the power available in the examples provided below), and/or any other logical storage system power state events that would be apparent to one of skill in the art in possession of the present disclosure. If, at decision block 706, no logical storage system power state event has been identified, the method 700 returns to decision block 710. As such, the method 700 may loop such that the logical storage power management engine 202a continues to monitor for the logical storage system power state event until a logical storage system power state event is identified.

If at decision block 710, a logical storage system power state event has been identified, the method 700 proceeds to block 712 where the storage controller device configures the logical storage system to operate in a logical storage system power state that is associated with the logical storage system power state event by configuring the storage devices to operate in the combination of supported power states that were used to determine that logical storage system power state. In one embodiment of decision block 710, the logical system power state event may be identified in response to the logical storage system 806 beginning operation following its creation, and may be associated with instructions to configure the logical storage system 806 to operate in a “default” logical storage system power state.

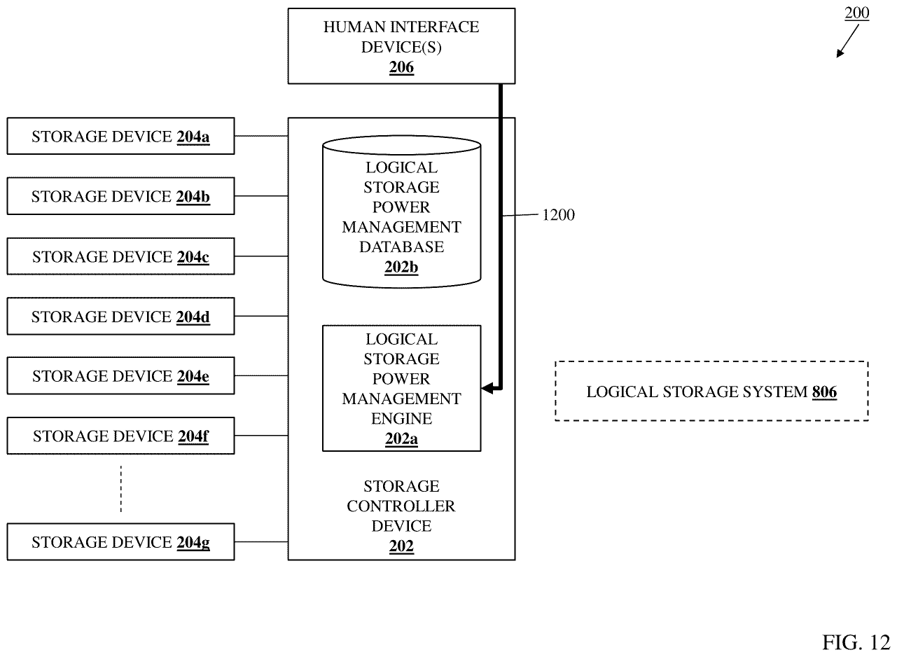

With reference to FIG. 12, in another embodiment of decision block 710, the logical storage power management engine 202a in the storage controller device 202 may perform logical storage system power state setting request receiving operations 1200 that include receiving a request from a user via the human interface device(s) 206 (e.g., the GUI and input device described above) to configure the logical storage system 806 to operate in one of the logical storage system power states that were displayed to that user as described above. In yet another embodiment of decision block 710, the logical system power state event may be identified in response to a reduction in the power available to the storage devices 204a-204g that were used to create the logical storage system 806, and may be associated with instructions to configure the logical storage system 806 to operate in a logical storage system power state that consumes less than the amount of power that is currently available to the storage devices 204a-204g. However, while several specific examples of logical storage system power state events have been described, one of skill in the art in possession of the present disclosure will appreciate that a variety of different logical storage system power state events will fall within the scope of the present disclosure as well.

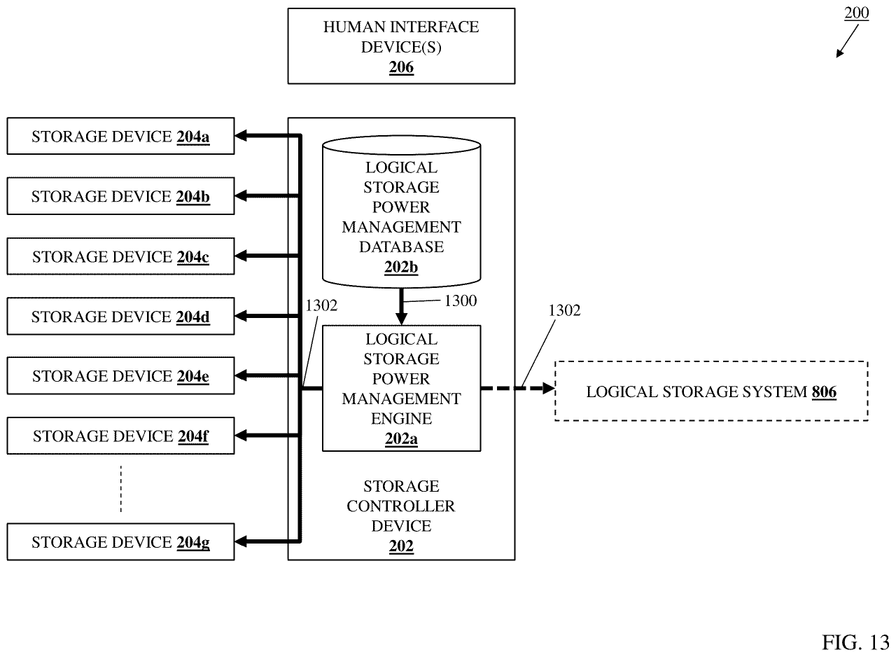

With reference to FIG. 13, in an embodiment of block 712, the logical storage power management engine 202a in the storage controller device 202 may perform supported power state combination retrieval operations 1300 that include retrieving the combination of the supported power states for the storage devices 204a-204g that provide the logical storage system power state associated with the logical storage system power state event from the logical storage power management database 202b. For example, in embodiments in which the logical storage system power state event is associated with instructions to configure the logical storage system 806 to operate in a “default” logical storage system power state, the logical storage power management engine 202a may retrieve the combination of the supported power states for the storage devices 204a-204g that provide that “default” logical storage system power state.

In another example, in embodiments in which the logical storage system power state event includes a request from a user to configure the logical storage system 806 to operate in one of the logical storage system power states that were displayed to that user, the logical storage power management engine 202a may retrieve the combination of the supported power states for the storage devices 204a-204g that provide that user-requested logical storage system power state. In yet another example, in embodiments in which the logical storage system power state event includes a reduction in the power available to the storage devices 204a-204g that were used to create the logical storage system 806 and is associated with instructions to configure the logical storage system 806 to operate in a logical storage system power state that consumes less than the amount of power that is available to the storage devices 204a-204g, the logical storage power management engine 202a may retrieve any combination of the supported power states for the storage devices 204a-204g that provide a logical storage system power state that consumes less than the amount of power available to the storage devices 204a-204g (e.g., a combination of the supported power states for the storage devices 204a-204g that provide a logical storage system power state that consumes an amount of power that allows the operation of the storage devices 204a-204g and any other components that are needed to perform any desired functionality). However, while several specific examples of combinations of supported power states for storage devices that provide a logical storage system power state have been described, one of skill in the art in possession of the present disclosure will appreciate that a variety of different combinations of supported power states for storage devices will fall within the scope of the present disclosure as well.

With reference back to FIG. 13, the logical storage power management engine 202a in the storage controller device 202 may perform storage device supported power state configuration operations 1302 that include configuring each of the storage devices 204a-204g to operate in their respective supported power states that provide the combination of supported power states that were retrieved from the logical storage power management database 202b. As such, continuing with the examples provided above, the storage devices 204a-204g may be configured with the combination of the supported power states that provide that “default” logical storage system power state, the storage devices 204a-204g may be configured with the combination of the supported power states that provide the logical storage system power state requested by the user, or the storage devices 204a-204g may be configured with the combination of the supported power states that provide the logical storage system power state that consumes less than the amount of power available to the storage devices 204a-204g.

As illustrated in FIG. 13 by the bolded and dashed arrow between the logical storage power management engine 202a and the logical storage system 806, the storage device supported power state configuration operations 1302 will cause the storage devices 204a-204g to operate in their supported power states in a combination that results in the logical storage system 806 operating in the logical storage system power state associated with the logical storage system power state event. As such, continuing with the examples provided above, the storage devices 204a-204g may operate in a combination of supported power states that results in the logical storage system 806 operating in the “default” logical storage system power state, the storage devices 204a-204g may operate in a combination of supported power states that results in the logical storage system 806 operating in the logical storage system power state requested by the user, or the storage devices 204a-204g may operate in a combination of supported power states that results in the logical storage system 806 operating in the logical storage system power state that consumes less than the amount of power available to the storage devices 204a-204g.

The method 700 then returns to decision block 710. As such, the method 700 may loop such that the logical storage system 806 continues to operate in the logical storage system power state that was configured at block 712 until another logical storage system power state event is identified. To provide a specific example, a first iteration of the method 700 may cause the logical storage system 806 to operate in the “default” logical storage system power state, followed by a user requesting a change in the logical storage system power state at the second iteration of decision block 710 that causes the logical storage system 806 to operate in the logical storage system power state requested by the user during a second iteration of block 712, followed by a reduction in the power available to the storage devices 204a-204g at the third iteration of decision block 710 that causes the logical storage system 806 to operate in the logical storage system power state that consumes less than the amount of power available to the storage devices 204a-204g. Furthermore, one of skill in the art in possession of the present disclosure will appreciate how the power available to the storage devices 204a-204g may be restored at the fourth iteration of decision block 710 that causes the logical storage system 806 to resume operating in the logical storage system power state that was requested by the user during the second iteration of block 712.

Thus, systems and methods have been described that provide for the determination of power states for a logical storage system using different combinations of power states supported by the storage devices that provide that logical storage system. For example, the multi-storage-device logical storage power management system of the present disclosure may include a plurality of storage devices, and a storage controller device that is coupled to the plurality of storage devices. The storage controller device uses the plurality of storage devices to create a logical storage system. The storage controller device then identifies supported power states for each of the plurality of storage devices, and uses a plurality of different combinations of the supported power states identified for each of the plurality of storage devices to determine a plurality of logical storage system power states. The storage controller device may then configure the logical storage system to operate in any one of the plurality of logical storage system power states by configuring the plurality of storage devices to operate in a respective one of the different combinations of the supported power states identified for each of the plurality of storage devices. As such, the management of power utilized by a logical storage system provided using a plurality of storage devices that support a variety of different power state levels and power state characteristics is enabled.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A multi-storage-device logical storage power management system, comprising:
a plurality of storage devices; and
a storage controller device that is coupled to the plurality of storage devices and that is configured to:
create, using the plurality of storage devices, a logical storage system that provides a logical storage space;
identify supported power states for each of the plurality of storage devices;
determine, using a plurality of different combinations of the supported power states identified for each of the plurality of storage devices, a plurality of logical storage system power states that each identify a respective aggregate power characteristic for the logical storage system that is determined by aggregating power characteristics of the supported power states in a respective combination of the plurality of different combinations; and
configure the logical storage system to operate in a first logical storage system power state that is included in the plurality of logical storage system power states by configuring the plurality of storage devices to operate in a first combination of the supported power states that corresponds to the respective aggregate power characteristic identified by the first logical storage system power state.

2. The system of claim 1, wherein the storage controller is configured to:
reconfigure, following the configuration of the logical storage system to operate in the first logical storage system power state, the logical storage system to operate in a second logical storage system power state that is included in the plurality of logical storage system power states and that is different than the first logical storage system power state by configuring the plurality of storage devices to operate in a second combination of the supported power states that corresponds to the respective aggregate power characteristic identified by the second logical storage system power state.

3. The system of claim 1, wherein the storage controller is configured to configure the logical storage system to operate in the first logical storage system power state based on at least one of:
a request received via a human interface device from a user to configure the logical storage system to operate in the first logical storage system power state; or
an identification of a reduction of power available to the plurality of storage device.

4. The system of claim 1, wherein the storage controller is configured to:
provide, for display to a user on a human interface device, the plurality of logical storage system power states.

5. The system of claim 1, wherein the storage controller is configured to:
determine that a second combination of the supported power states identified for each of the plurality of storage devices and a third combination of the supported power states identified for each of the plurality of storage devices both provide the first logical storage system power state; and
define the first combination of the supported power states identified for each of the plurality of storage devices to include either the second combination of the supported power states identified for each of the plurality of storage devices or the third combination of the supported power states identified for each of the plurality of storage devices.

6. The system of claim 1, wherein each of the plurality of storage devices is provided by a respective Compute eXpress Link (CXL) memory device, and the storage controller is provided by a CXL switch device.

7. An Information Handling System (IHS), comprising:
a processing system; and
a memory system that is coupled to the processing system and that includes instructions that, when executed by the processing system, cause the processing system to provide a logical storage power management engine that is configured to:
create, using a plurality of storage devices that are coupled to the processing system, a logical storage system that provides a logical storage space;
identify supported power states for each of the plurality of storage devices;
determine, using a plurality of different combinations of the supported power states identified for each of the plurality of storage devices, a plurality of logical storage system power states that each identify a respective aggregate power characteristic for the logical storage system that is determined by aggregating power characteristics of the supported power states in a respective combination of the plurality of different combinations; and
configure the logical storage system to operate in a first logical storage system power state that is included in the plurality of logical storage system power states by configuring the plurality of storage devices to operate in a first combination of the supported power states that corresponds to the respective aggregate power characteristic identified by the first logical storage system power state.

8. The IHS of claim 7, wherein the logical storage power management engine is configured to:
reconfigure, following the configuration of the logical storage system to operate in the first logical storage system power state, the logical storage system to operate in a second logical storage system power state that is included in the plurality of logical storage system power states and that is different than the first logical storage system power state by configuring the plurality of storage devices to operate in a second combination of the supported power states that corresponds to the respective aggregate power characteristic identified by the second logical storage system power state.

9. The IHS of claim 7, wherein the logical storage power management engine is configured to:
receive, via a human interface device that is coupled to the processing system, a request from a user to configure the logical storage system to operate in the first logical storage system power state; and
configure the logical storage system to operate in the first logical storage system power state based on the request.

10. The IHS of claim 7, wherein the logical storage power management engine is configured to:
identify a reduction of power available to the plurality of storage device; and
configure the logical storage system to operate in the first logical storage system power state based on the identification of the reduction of power available to the plurality of storage devices.

11. The IHS of claim 7, wherein the logical storage power management engine is configured to:
provide, for display to a user on a human interface device that is coupled to the processing system, the plurality of logical storage system power states.

12. The IHS of claim 7, wherein the logical storage power management engine is configured to:
determine that a second combination of the supported power states identified for each of the plurality of storage devices and a third combination of the supported power states identified for each of the plurality of storage devices both provide the first logical storage system power state; and
define the first combination of the supported power states identified for each of the plurality of storage devices to include either the second combination of the supported power states identified for each of the plurality of storage devices or the third combination of the supported power states identified for each of the plurality of storage devices.

13. The IHS of claim 7, wherein the processing system and the memory system are provided in a CXL switch device, and each of the plurality of storage devices is provided by a respective Compute eXpress Link (CXL) memory device.

14. A method for managing power for a logical storage system provided by multiple storage devices, comprising:
creating, by a storage controller device using a plurality of storage devices, a logical storage system that provides a logical storage space;
identifying, by the storage controller device, supported power states for each of the plurality of storage devices;
determining, by the storage controller device using a plurality of different combinations of the supported power states identified for each of the plurality of storage devices, a plurality of logical storage system power states that each identify a respective aggregate power characteristic for the logical storage system that is determined by aggregating power characteristics of the supported power states in a respective combination of the plurality of different combinations; and
configuring, by the storage controller device, the logical storage system to operate in a first logical storage system power state that is included in the plurality of logical storage system power states by configuring the plurality of storage devices to operate in a first combination of the supported power states that corresponds to the respective aggregate power characteristic identified by the first logical storage system power state.

15. The method of claim 14, further comprising:
reconfiguring, by the storage controller device following the configuration of the logical storage system to operate in the first logical storage system power state, the logical storage system to operate in a second logical storage system power state that is included in the plurality of logical storage system power states and that is different than the first logical storage system power state by configuring the plurality of storage devices to operate in a second combination of the supported power states that corresponds to the respective aggregate power characteristic identified by the second logical storage system power state.

16. The method of claim 14, further comprising:
receiving, by the storage controller device via a human interface device, a request from a user to configure the logical storage system to operate in the first logical storage system power state; and
configuring, by the storage controller device, the logical storage system to operate in the first logical storage system power state based on the request.

17. The method of claim 14, further comprising:
identifying, by the storage controller device, a reduction of power available to the plurality of storage device; and
configuring, by the storage controller device, the logical storage system to operate in the first logical storage system power state based on the identification of the reduction of power available to the plurality of storage devices.

18. The method of claim 14, further comprising:
providing, by the storage controller device for display to a user on a human interface device, the plurality of logical storage system power states.

19. The method of claim 14, further comprising:
determining, by the storage controller device, that a second combination of the supported power states identified for each of the plurality of storage devices and a third combination of the supported power states identified for each of the plurality of storage devices both provide the first logical storage system power state; and
defining, by the storage controller device, the first combination of the supported power states identified for each of the plurality of storage devices to include either the second combination of the supported power states identified for each of the plurality of storage devices or the third combination of the supported power states identified for each of the plurality of storage devices.

20. The method of claim 14, wherein each of the plurality of storage devices is provided by a respective Compute eXpress Link (CXL) memory device, and the storage controller is provided by a CXL switch device.
